(19) United States
(12) Patent Application Publication
(10) Pub. No.: US 2015/0114713 A1
(43) Pub. Date: Apr. 30, 2015

(54) LATERAL EDGE WATER-RESISTANCE STRUCTURE FOR FLEXIBLE CIRCUIT CABLE

(71) Applicant: ADVANCED FLEXIBLE CIRCUITS CO., LTD., TAOYUAN COUNTY (TW)

(72) Inventors: GWUN-JIN LIN, TAOYUAN COUNTY (TW); KUO-FU SU, TAOYUAN COUNTY (TW)

(73) Assignee: ADVANCED FLEXIBLE CIRCUITS CO., LTD., TAOYUAN COUNTY (TW)

(21) Appl. No.: 14/198,819

(22) Filed: Mar. 6, 2014

(30) Foreign Application Priority Data
Oct. 30, 2013 (TW) 102139245

(51) Int. Cl. H01B 7/282; H01B 3/46; H01B 3/30; H01B 7/04; H01B 3/28

(52) U.S. Cl. CPC H01B 7/2825; H01B 7/04; H01B 3/28; H01B 3/308; H01B 3/46; H01B 3/30
USPC 174/88 R

(57) ABSTRACT

Disclosed is a lateral edge water-resistance structure for a flexible circuit cable. The flexible circuit cable includes a water resistant section formed thereon. The flexible circuit cable has two lateral edges in the water resistant section and a roughness structure is formed in at least one of the lateral edges or in both lateral edges of the flexible circuit cable. A water-resistance module is molded to cover the water resistant section and the roughness structure of the flexible circuit cable. With the arrangement of the water-resistance module and the roughness structure, the flexible circuit cable is provide with a water resistant effect for the lateral edge.

### BACKGROUND OF THE INVENTION

1. Field of the Invention

The present invention relates to a flexible circuit cable including water-resistance structure, and in particular to a water resistance structure for a flexible circuit cable that comprises a roughness structure formed in a lateral edge of a flexible substrate and covered through molding of a water-resistance module.

2. The Related Arts

In applications where a flexible circuit cable is used to connect electronic devices, generally no water resistance issue must be taken into consideration. However. for applications of outdoor-purposes or portable electronic devices (such as mobile phones), the issues of water resistance and moisture resistance become a concern. For example, in the applications of mobile phones, a flexible circuit cable is connected between a host device and a display screen of the mobile phone by means of connectors or soldering. If there is no water resistance structure arranged between the flexible circuit cable and the host device or display screen of the mobile phone, water may flow along the flexible circuit cable into the interiors of the host device or display screen of the mobile phone.

To achieve the purposes of water resistance or moisture resistance, a common practice that was generally taken in the known designs is to place a rubber pad as a water-resistance module between an enclosure of an electronic device and a flat cable, whereby the purposes of water resistance or moisture resistance can be achieved through tight engagement established between the water-resistance module and the enclosure of the electronic device.

Recently developed techniques allow for directly inlaying a water-resistance module in an insulation surface material of a flexible circuit cable, which achieves the purposes of basic water resistance or moisture resistance. However, there are still concerns about reliability between the water-resistance module and the flat cable. For example, at the contacting site between the water-resistance module and the flat cable, the water-resistance module is fit to an opening of an enclosure of a device, so that the water-resistance module is tightly coupled, but is also compressed and shows a concaved surface contour, leading to deformation of the water-resistance module. This may cause the formation of a gap at a lateral edge of a flexible circuit cable to which the water-resistance module is attached. Such a gap may allow water or humid air flow to flow through lateral edge of the flexible circuit cable into the interior of a portable electronic device.

Further, due to frequent use of a portable electronic device, frequent flexing of a flexible circuit cable to which a water-resistance module is attached results and position shifting and/or gaps may readily occur between the water-resistance module and the flat cable at a lateral edge thereof. Thus, it is a concern of development in the industry to overcome the technical insufficiency discussed above.

### SUMMARY OF THE INVENTION

Thus, to overcome the above problems, the present invention provides a lateral edge water-resistance structure for a flexible circuit cable, wherein the flexible circuit cable comprises a water resistant section formed thereon. At least one lateral edge or two opposite lateral edges of the flexible circuit cable is each provided with a regular or an irregular roughness structure in the water resistant section. A water-resistance module is molded to cover the water resistant section and the roughness structure.

In a preferred embodiment, the flexible circuit cable is a single-sided cable, or a double-sided cable, or a multiple-layered cable and can alternatively be a rigid-flex cable.

The flexible circuit cable has a metal layer that forms a metal layer exposure zone corresponding in position to the water resistant section. The water-resistance module is molded in such a way as to cover the metal layer exposure zone. The metal layer exposure zone has a roughened structure.

The roughness structure can be formed in either one of or both of an insulation cover layer and a substrate of the flexible circuit cable. The roughness structure can be constructed as one of a wavy configuration, a serrated configuration, and a circular arc configuration. The roughness structure can be constructed in such a way that a lateral edge in a water resistant section is shaped in a recessing direction or a projection direction to form the roughness structure.

The water-resistance module is made of an insulation material, which includes one of silicon rubber, rubber, silica gel, plastic, and resin, or is alternatively made of an electrically conductive material, which includes one of silicon rubber, rubber, silica gel, plastic, and resin that comprises electrically conductive particles combined therein.

The flexible circuit cable may further comprise a liner layer attached thereto in the water resistant section. The liner layer has a surface that comprises a roughened structure formed thereon. Alternatively, the surface of the liner layer comprises a plurality of cavities formed therein but not extending through the liner layer or alternatively, the liner layer comprises a plurality of through holes formed therein and extending the liner layer.

As to the efficacy, the present invention uses a roughness structure to provide excellent water resistance and adhesion between a water-resistance module and a flat cable and preventing liquid from flowing through a lateral edge of the flexible circuit cable into an electronic device to cause damage of the device. The water-resistance structure of the present invention provides an excellent effect of water resistance at lateral edges of flexible circuit cable, in addition to water resistance at top and bottom surfaces of the flexible circuit cable. Further, in practical applications, since the formation of a roughness structure in a lateral edge of a flexible circuit cable can be done with a simple process, excellent value of industrial use can be achieved.

### BRIEF DESCRIPTION OF THE DRAWINGS

The present invention will be apparent to those skilled in the art by reading the following description of preferred embodiments of the present invention, with reference to the attached drawings, in which:

FIG. 1 is a perspective view showing a lateral edge water-resistance structure for a flexible circuit cable according to the present invention;

FIG. 2 is a cross-sectional view taken along line 2-2 of FIG. 1;

FIG. 3 is a cross-sectional view taken along line 3-3 of FIG. 1;

FIG. 4 is a perspective view showing a lateral edge water-resistance structure for a flexible circuit cable according to the present invention inlaid in a device enclosure;

FIG. 5 is a cross-sectional view taken along line 5-5 of FIG. 4;

FIG. 6 is a schematic view showing a first embodiment of the present invention;

FIG. 7 is a schematic view showing a second embodiment of the present invention;

FIG. 8 is a schematic view showing a third embodiment of the present invention;

FIG. 9 is a schematic view showing a fourth embodiment of the present invention;

FIG. 10 is a schematic view showing a fifth embodiment of the present invention;

FIG. 11 is a schematic view showing a surface metal layer is formed on a vertical surface of a roughness structure according to the present invention;

FIG. 12 is a schematic view showing a sixth embodiment of the present invention;

FIG. 13 is a schematic view showing a seventh embodiment of the present invention;

FIG. 14 is a cross-sectional view showing an eighth embodiment of the present invention;

FIG. 15 is a cross-sectional view showing a ninth embodiment of the present invention;

FIG. 16 is a cross-sectional view showing a tenth embodiment of the present invention;

FIG. 17 is a cross-sectional view showing an eleventh embodiment of the present invention;

FIG. 18 is a cross-sectional view showing a twelfth embodiment of the present invention;

FIG. 19 is a cross-sectional view showing a thirteenth embodiment of the present invention;

FIG. 20 is a cross-sectional view showing a fourteenth embodiment of the present invention;

FIG. 21 is a cross-sectional view showing a fifteenth embodiment of the present invention;

FIG. 22 is across-sectional view showing a sixteenth embodiment of the present invention; and

FIG. 23 is across-sectional view showing a seventeenth embodiment of the present invention.

### DETAILED DESCRIPTION OF THE PREFERRED EMBODIMENTS

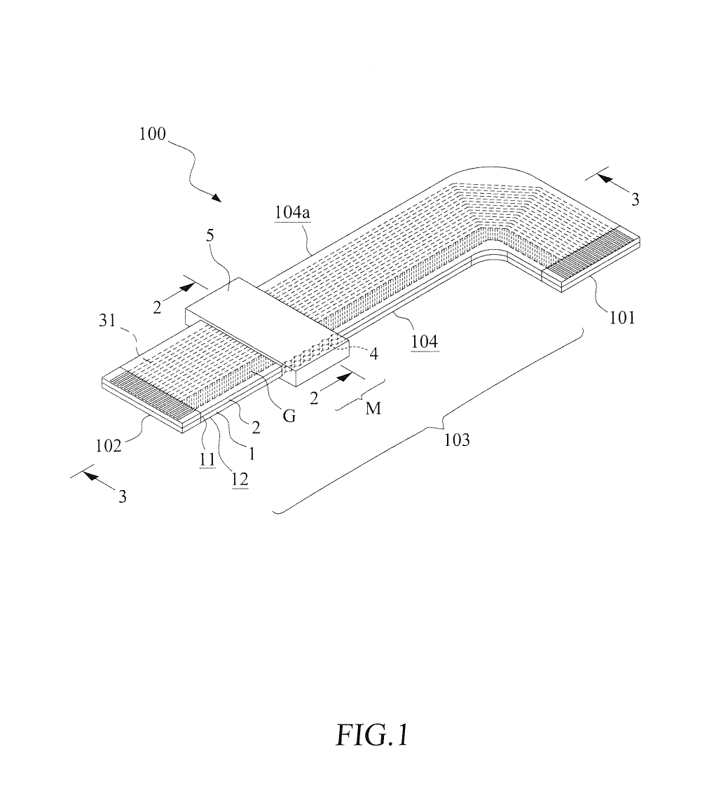

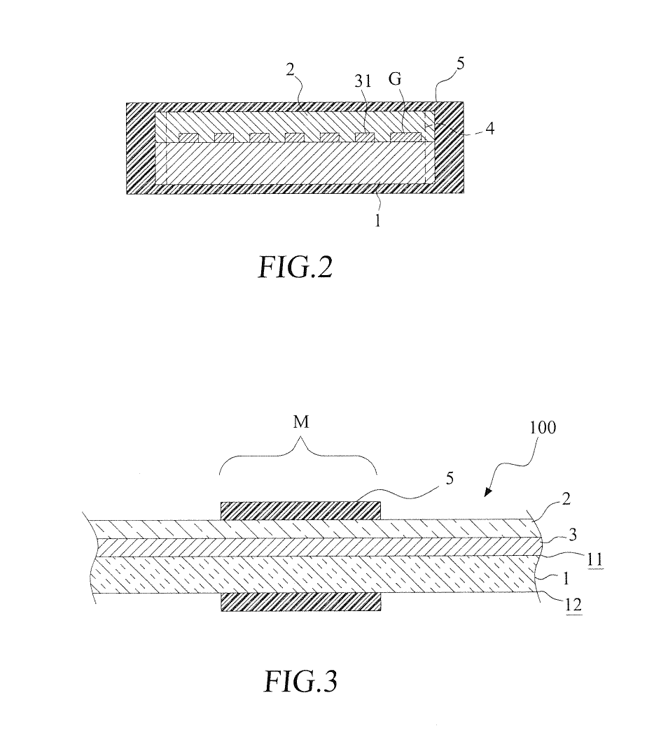

With reference to the drawings and in particular to FIGS. 1-3, the present invention provides a flexible circuit cable 100 comprising a first end 101, a second end 102, and an extension section 103 connected between the first end 101 and the second end 102. The extension section 103 has two opposite lateral edges 104, 104a. The flexible circuit cable 100 comprises a substrate 1 and an insulation cover layer 2. The substrate 1 has a first surface 11 and a second surface 12. The first surface 11 comprises a metal layer 3 formed thereon and the insulation cover layer 2 is set to cover the metal layer 3. The metal layer 3 comprises a plurality of signal lines 31 that is formed on the first surface 11 of the substrate 1 in an adjacent but isolated manner and at least a grounding line G.

The extension section 103 of the flexible circuit cable 100 comprises a water resistant section M formed therein. The water resistant section M has portions that are cut off and respectively correspond to the lateral edge 104, 104a so as to form a roughness structure 4 in at least one or both of the two lateral edges 104, 104a. The roughness structure 4 can be either a regular or an irregular rough configuration. In practical application, the roughness structure 4 may be a wavy configuration, a serrated configuration, or a circular arc configuration.

A water-resistance module 5 is coupled to the water resistant section M and the water-resistance module 5 is molded to cover the second surface 12, the insulation cover layer 2 and the roughness structure 4 of the substrate 1. The water-resistance module 5 is made of an insulation material of one of silicon rubber, rubber, silica gel, plastic, and resin, whereby an effect of insulation is achieved by using these materials. Alternatively, the water-resistance module 5 is made of an electrically conductive material of one of silicon rubber, rubber, silica gel, plastic, and resin, which comprises electrically conductive particles combined therein, whereby effects of electrical conductivity and anti-magnetism can be achieved by using theses materials.

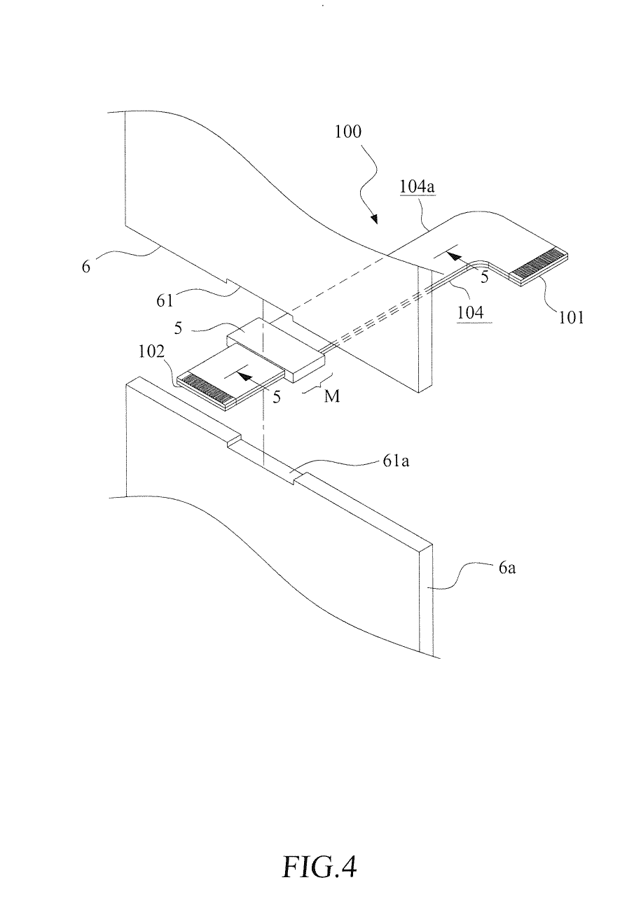

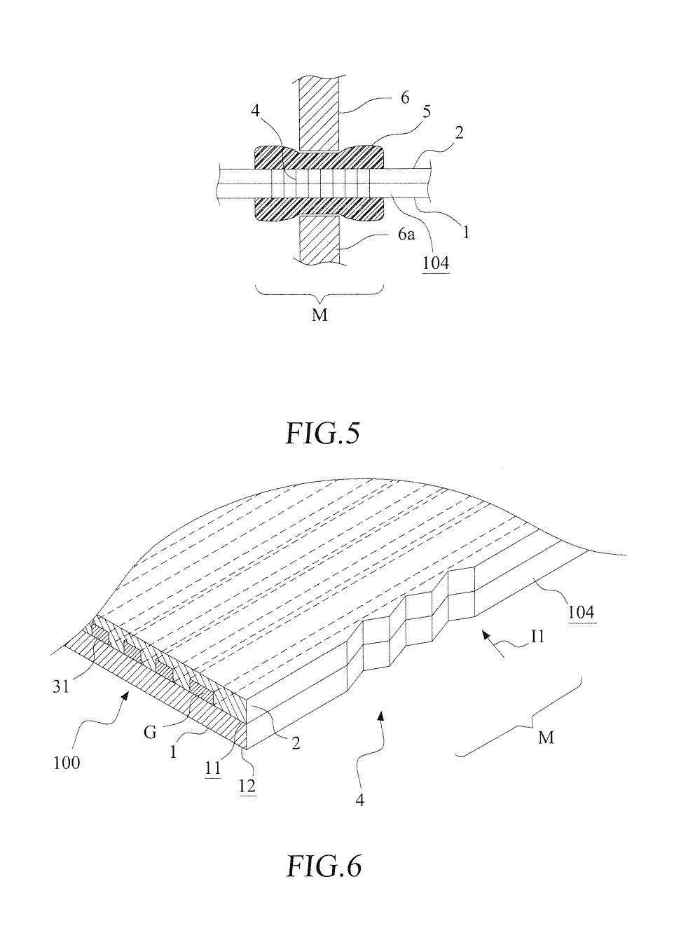

Referring to FIGS. 4 and 5, a situation where after the water-resistance module 5 is coupled to the water resistant section M of the flexible circuit cable 100, the water-resistance module 5 is inlaid in or fit into openings 61, 61a formed in a device enclosure 6, 6a. The water-resistance module 5 provides the flexible circuit cable 100 with an excellent resistance against water so as to prevent water from invading into an interior space defined in the enclosure 6, 6a. The later edge water-resistance structure of the flexible circuit cable according to the present invention is applicable to any suitable electronic device, such as a portable communication device and a notebook computer.

Referring to FIG. 6, which is a schematic view showing a first embodiment of the present invention, as shown in the drawing, a flexible circuit cable 100 comprises a substrate 1, an insulation cover layer 2, a plurality of signal lines 31, and a grounding line G. The flexible circuit cable 100 comprises a roughness structure 4 that shows a serrated configuration formed in a lateral edge 104 of a water resistant section M. In the instant embodiment, the lateral edge 104 of the flexible circuit cable 100 is cut to remove portions of the substrate 1 and the insulation cover layer 2 so as to form the serrated configuration of the roughness structure 4. Afterwards, the water-resistance module 5 is applied to tightly enclose around the serrated configuration of the roughness structure 4, the insulation cover layer 2, and the second surface 12 of the substrate 1 to provide an excellent effect of water resistance. In other words, the roughness structure is constructed by partly recessing the lateral edge 104 of the flexible circuit cable 100 in a recessing direction 11 so as to form the roughness structure.

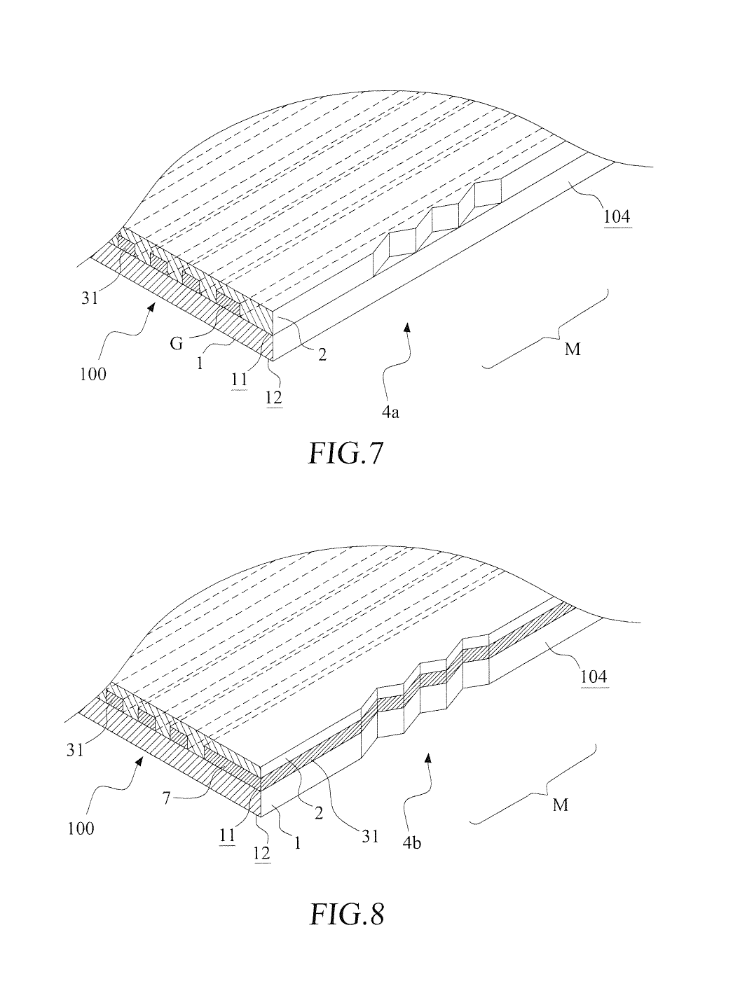

Referring to FIG. 7, which is a schematic view showing a second embodiment of the present invention, the instant embodiment has a structure that is similar to that of the embodiment with reference to FIG. 6 and a difference resides in that the lateral edge 104 of the flexible circuit cable 100 is only cut to remove a portion of the insulation cover layer 2 to form the serrated configuration of the roughness structure 4a, with the substrate 1 being not cut. This provides an equivalent serrated configuration of the roughness structure. It is also possible to cut off only the substrate 1 to form the roughness structure 4a. In other words, the roughness structure can be formed in either the insulation cover layer or the substrate of the flexible circuit cable or both.

Referring to FIG. 8, which is a schematic view showing a third embodiment of the present invention, the instant embodiment has a structure that is similar to that of the embodiment with reference to FIG. 6, but a copper residue zone 7 is formed on the first surface 11 of the substrate 1 at a location adjacent to the lateral edge 104. The serrated configuration of the roughness structure 4b of the instant embodiment is formed by cutting the lateral edge 104 of the flexible circuit cable 100 to remove portions of the substrate 1, the copper residue zone 7, and the insulation cover layer 2. In a practical manufacturing process, the serrated configuration of the roughness structure 4b can alternatively be formed in one of the substrate 1, the copper residue zone 7, and the insulation cover layer 2 of the flexible circuit cable 100. The copper residue zone 7 is an area where a copper material is coated, which is left in a wire etching process of the flexible circuit cable and the copper residue zone 7 can be used as a grounding line of the flexible circuit cable 100.

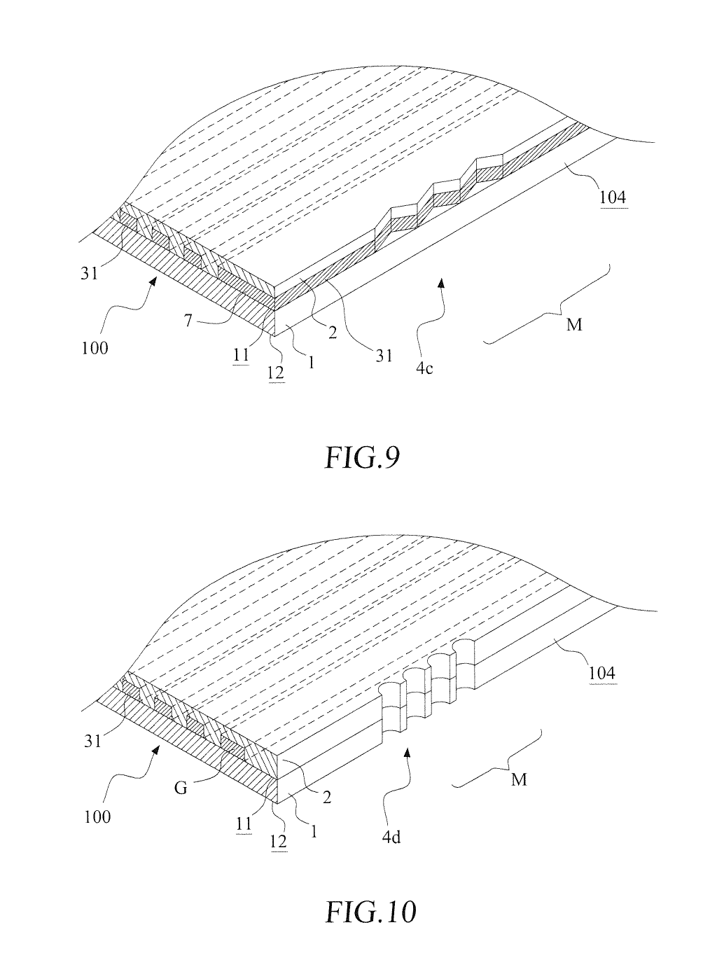

Referring to FIG. 9, which is a schematic view showing a fourth embodiment of the present invention, the instant embodiment has a structure that is similar to that of the embodiment with reference to FIG. 8, namely the first surface 11 of the substrate 1 comprising a copper residue zone 7 formed thereon adjacent to the lateral edge 104. However, the serrated configuration of the roughness structure 4c according to the instant embodiment is such that the lateral edge 104 of the flexible circuit cable 100 is cut to remove portions of the copper residue zone 7 and the insulation cover layer 2. It is also possible that the roughness structure of the present invention is formed in either one of the insulation cover layer, the copper residue zone, and the substrate of the flexible circuit cable or formed in all three of them.

Referring to FIG. 10, which is a schematic view showing a fifth embodiment of the present invention, the instant embodiment has a structure that is similar to that of the embodiment with reference to FIG. 6, namely the lateral edge 104 of the flexible circuit cable 100 is cut to remove portions of the substrate 1 and the insulation cover layer 2 to form the roughness structure. However, the roughness structure is a multiple circular arc included roughness structure 4d.

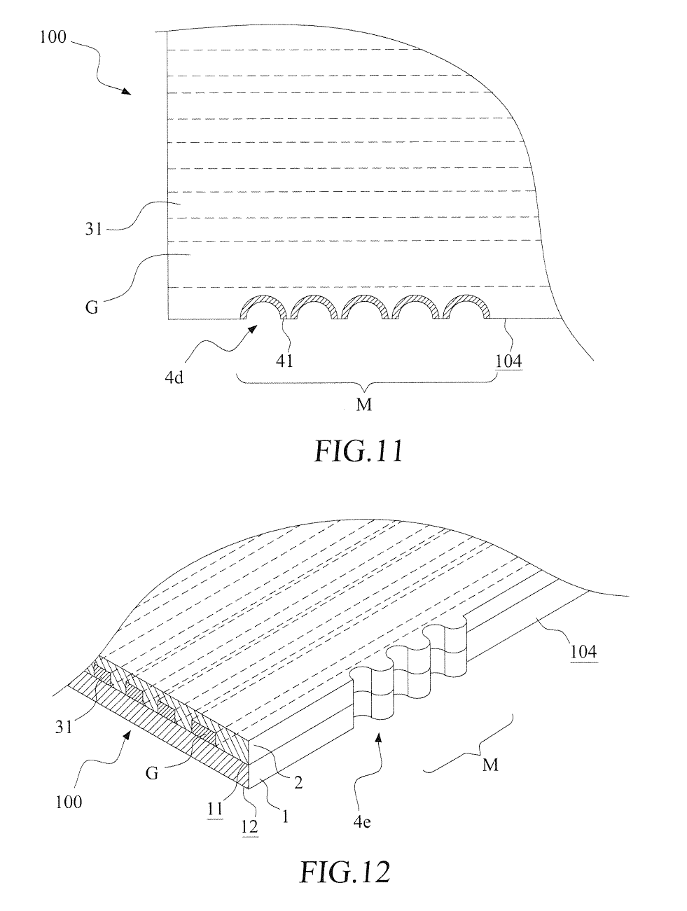

Further, as shown in FIG. 11, the present invention may alternatively comprise a metal layer 41 formed on a vertical surface of the roughness structure 4d. In a practical manufacturing process of forming the metal layer 41, a known manufacturing technical of forming conductive vias in a regular flexible circuit cable is applied to complete the manufacture thereof. For example, a plurality of aligned holes can be formed in the flexible circuit cable 100 at locations adjacent to the lateral edge and each of hole is formed with a thin metal layer 41 on an inner circumference thereof to form a plurality of vias. Finally, the vias are cut off at about centers thereof to remove a half of each via and preserve the remaining half to provide a roughness structure 4d having a surface on which a metal layer 41 is formed as shown in FIG. 11. The arrangement of metal layer 41 is applicable to each of the embodiments described for the present invention. With such a surface-attached metal layer 41, bettered adhesion can be obtained for coupling the water-resistance module 5 to the roughness structure 4d.

Referring to FIG. 12, which is a schematic view showing a sixth embodiment of the present invention, the instant embodiment has a structure that is similar to that of the embodiment with reference to FIG. 6, the roughness structure is also formed by cutting the lateral edge 104 of the flexible circuit cable 100 to remove portions of the substrate 1 and the insulation cover layer 2, but the roughness structure is a roughness structure 4e of a wavy configuration.

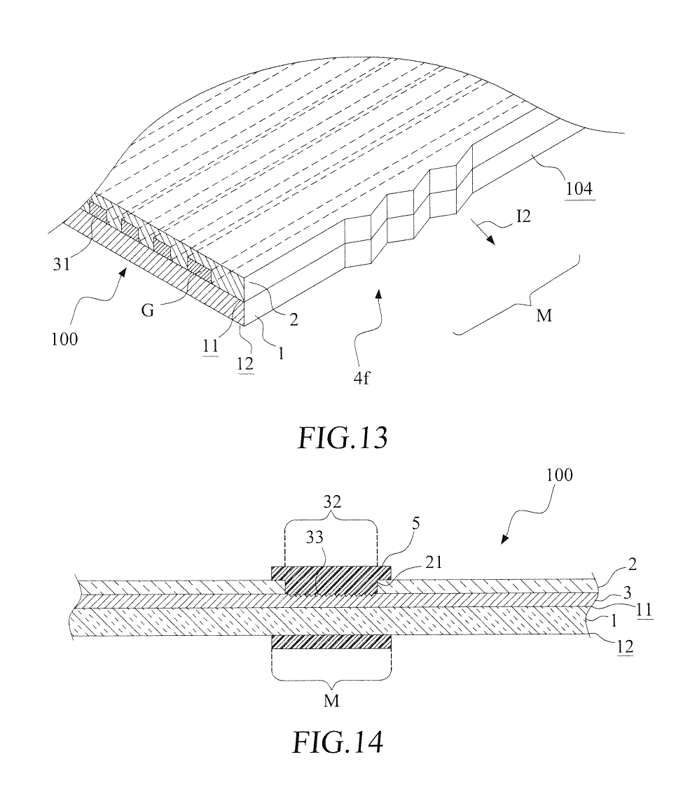

Referring to FIG. 13, which is a schematic view showing a seventh embodiment of the present invention, the instant embodiment has a structure that is similar to that of the embodiment with reference to FIG. 6, but the serrated configuration of the roughness structure 4f is formed by projecting, in an integral form, from the lateral edge 104 of the flexible circuit cable 100 in a projection direction 12.

Referring to FIG. 14, which is a schematic view showing an eight embodiment of the present invention, different from the embodiment with reference to FIG. 3, the instant embodiment provides a flexible circuit cable 100 that has an insulation cover layer 2 comprising a water-resistance module inlay zone 21 formed in a water resistant section M and a metal layer 3 comprising a metal layer exposure zone 32 defined in a surface thereof corresponding to the water-resistance module inlay zone 21. A water-resistance module 5 is tightly coupled and fixed to the water-resistance module inlay zone 21 of the insulation cover layer 2, the metal layer exposure zone 32 of the metal layer 3, and the second surface 12 of the substrate 1. Preferably, the metal layer exposure zone 32 has a roughened structure 33. In practice, the roughened structure 33 may comprise a plurality of cavities that does not extend through the metal layer 3, or through holes that extend through the metal layer 3, or just a roughened surface formed on the metal layer 3.

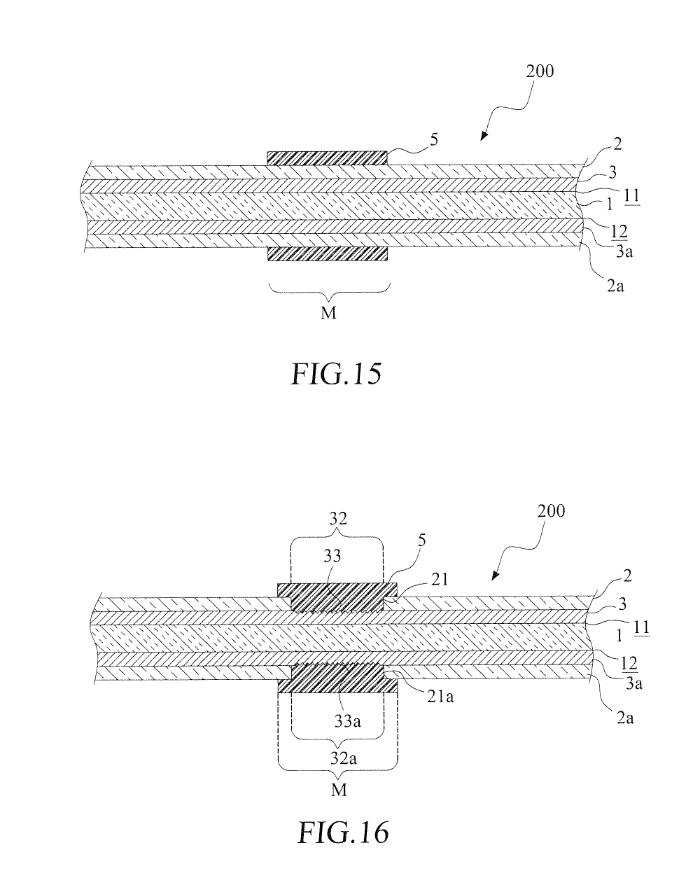

Referring to FIG. 15, which is a schematic view showing a ninth embodiment of the present invention, besides being applicable to the previously discussed embodiments that are single-sided circuit cables, the present invention may also be used in double-sided circuit cables and multiple-layered circuit cables. For example, in a double-sided structure of a flexible circuit cable, a first surface 11 and a second surface 12 of a substrate 1 each comprise a metal layer 3, 3a and an insulation cover layer 2, 2a formed thereon. And, a roughness structure, which can be embodied as any of the previously discussed embodiments, is formed in a lateral edge of the flexible circuit cable in a water resistant section M. Afterwards, a water-resistance module 5 is tightly coupled to the insulation cover layers 2, 2a in the water resistant section M.

Referring to FIG. 16, which is a schematic view showing a tenth embodiment of the present invention, the instant embodiment has a structure that is similar to that of the embodiment with reference to FIG. 15 and is also applied to a double-sided circuit cable structure. In the instant embodiment, a flexible circuit cable comprises insulation cover layers 2, 2a, each forming a water-resistance module inlay zone 21, 21a, and metal layer 3 are each provided with a metal layer exposure zone 32, 32a and a roughened structure 33, 33a for a surface thereof corresponding to the water-resistance module inlay zone 21, 21a. A water-resistance module 5 is tightly coupled to the water-resistance module inlay zones 21, 21a of the insulation cover layer 2 and the metal layer exposure zones 32, 32a of the metal layer 3.

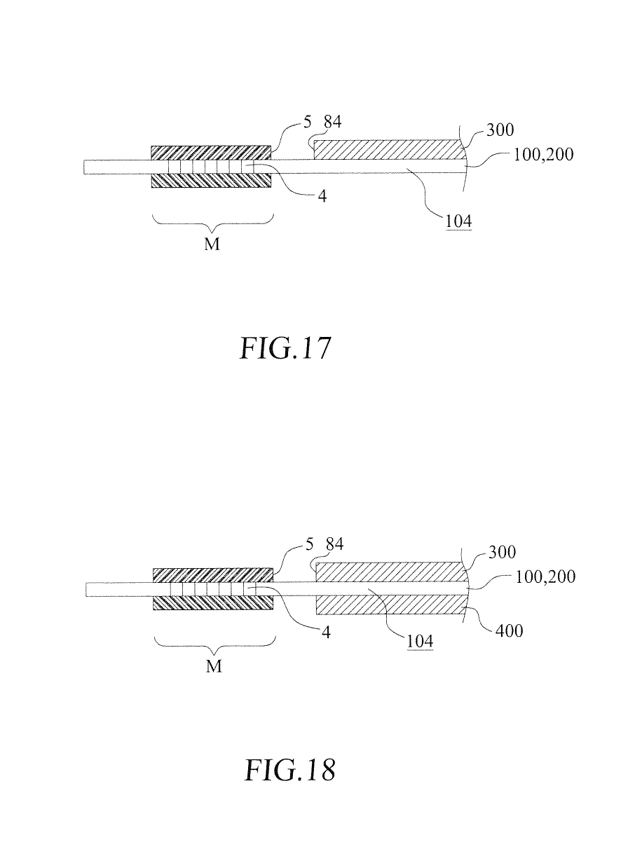

FIG. 17 is a cross-sectional view showing an eleventh embodiment of the present invention, where a water-resistance module inlaid in and attached to a rigid-flex cable is illustrated. Similar to FIG. 3, a flexible circuit cable 100 comprises a water resistant section M formed thereon. A lateral edge 104 of the flexible circuit cable 100 comprises a roughness structure 4 formed therein. Further, one of surfaces of the flexible circuit cable 100 comprises a rigid circuit board 300 bonded thereto in such a way that an end edge 84 of the rigid circuit board 300 is spaced from the water resistant section M by a distance. A water-resistance module 5 is molded to cover the water resistant section M and the roughness structure 4. The flexible circuit cable 100 can be a single-sided circuit cable (as shown in FIG. 3) or a double-sided flexible circuit cable 200 (as shown in FIG. 15).

FIG. 18 is a cross-sectional view showing a twelfth embodiment of the present invention, where a water-resistance module is inlaid in and attached to a rigid-flex cable of a different form. In the instant embodiment, a flexible circuit cable 100 also comprises a roughness structure 4 formed in a lateral edge 104 in a water resistant section M. The flexible circuit cable 100 has a top surface and a bottom surface to each of which a rigid circuit board 300, 400 is bonded. Each rigid circuit board 300, 400 has an end edge 84 that is spaced from the water resistant section M by a distance. A water-resistance module 5 is molded to cover the water resistant section M and the roughness structure 4. The flexible circuit cable 100 can be a single-sided cable or alternatively a double-sided flexible circuit cable 200.

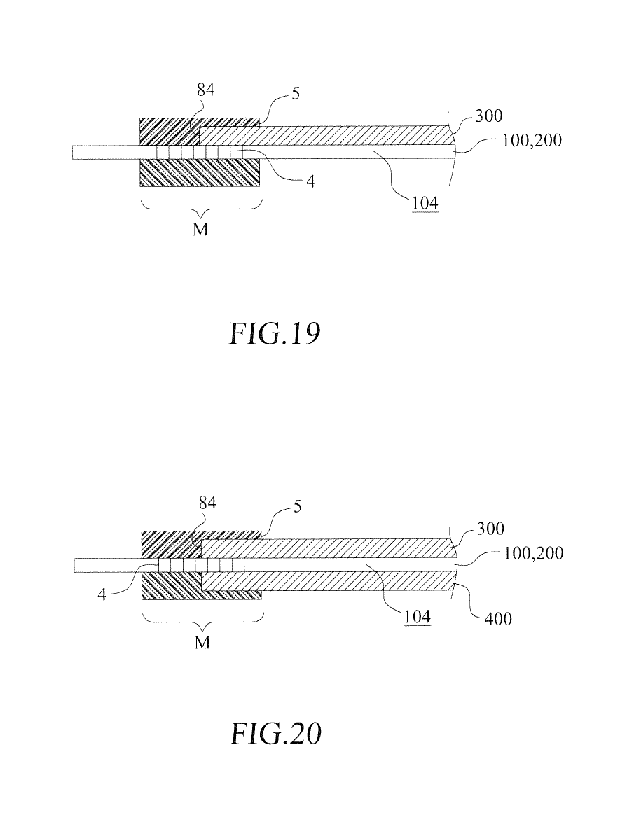

FIG. 19 is a cross-sectional view showing a thirteenth embodiment of the present invention, where a water-resistance module is inlaid in and attached to a rigid-flex cable. In the instant embodiment, a flexible circuit cable 100 also comprises a roughness structure 4 formed in a lateral edge 104 in a water resistant section M. The flexible circuit cable 100 has a top surface to which a rigid circuit board 300 is bonded. The rigid circuit board 300 has an end edge 84 extending to the water resistant section M. A water-resistance module 5 is molded to cover the water resistant section M, the roughness structure 4, and a portion of the rigid circuit board 300. Similarly, the flexible circuit cable 100 can be a single-sided cable, or alternatively a double-sided flexible circuit cable 200.

FIG. 20 is a cross-sectional view showing a fourteenth embodiment of the present invention, where a water-resistance module is inlaid in and attached to a rigid-flex cable. In the instant embodiment, a flexible circuit cable 100 also comprises a roughness structure 4 formed in a lateral edge 104 in a water resistant section M. The flexible circuit cable 100 has a top surface and a bottom surface to each of which a rigid circuit board 300, 400 is bonded. Each rigid circuit board 300, 400 has an end edge 84 extending to the water resistant section M. A water-resistance module 5 is molded to cover the water resistant section M, the roughness structure 4, and a portion of each of the rigid circuit boards 300, 400. Similarly, the flexible circuit cable 100 can be a single-sided cable or alternatively a double-sided flexible circuit cable 200.

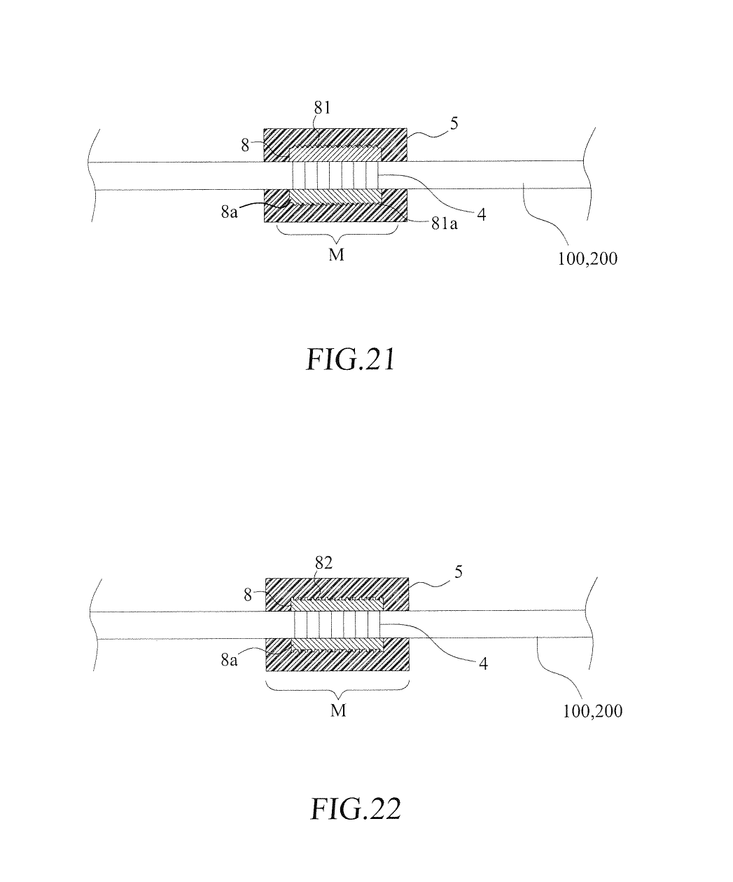

FIG. 21 is a cross-sectional view showing a fifteenth embodiment of the present invention, where a water-resistance module is inlaid in and attached to a flexible circuit cable. A difference from the previous embodiments is that either a single-sided flexible circuit cable 100 or a double-sided flexible circuit cable 200 has a top surface and a bottom surface to each of which a liner layer 8, 8a is attached in a water resistant section M. The liner layer 8, 8a has a surface on which a roughened structure 81, 81a is formed. Afterwards, a water-resistance module 5 is molded to cover the water resistant section M. The arrangement of the liner layers 8, 8a makes the coupling between the water-resistance module 5 and the flexible circuit cable 100, 200 more tightly and more securely, without undesired separation. In a practical application, it is possible to provide only one of the two surfaces of the flexible circuit cable 100, 200 with a liner layer attached thereto to achieve the same effect.

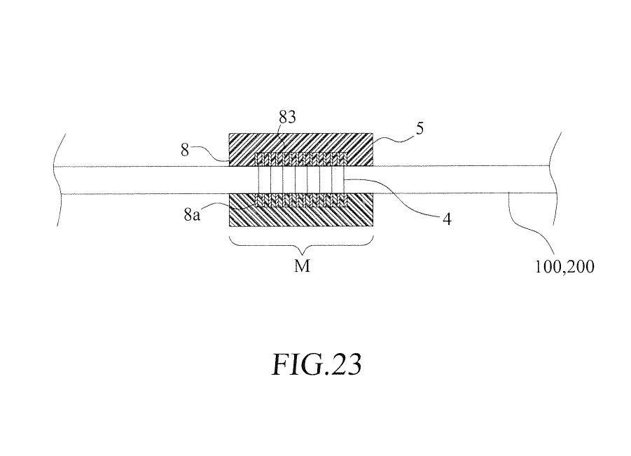

The roughened structures 81, 81a of the liner layers 8, 8a can be formed as roughened surfaces on the surfaces of the liner layers 8, 8a with any known techniques, or alternatively, a plurality of cavities 82 that does not extend through the liner layers 8, 8a is formed on the surfaces of the liner layers 8, 8a (see FIG. 22 that is a cross-sectional view showing a sixteenth embodiment according to the present invention) or alternatively, a plurality of through holes 83 is formed in the liner layers 8, 8a to extend through the liner layers 8, 8a (see FIG. 23 that is a cross-sectional view showing a seventeenth embodiment of the present invention).

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lateral edge water-resistance structure for a flexible circuit cable, wherein the flexible circuit cable comprises a first end, a second end, and an extension section connected between the first end and the second end, the extension section having two opposite lateral edges, characterized in that:
the extension section of the flexible circuit cable comprises a water resistant section formed thereon, at least one lateral edge of the two lateral edges of the extension section of the flexible circuit cable comprising a roughness structure formed thereon in the water resistant section; and
a water-resistance module is molded to cover the water resistant section and the roughness structure.

2. The lateral edge water-resistance structure as claimed in claim 1, wherein the flexible circuit cable comprises:
a substrate, which has a first surface and a second surface;
a metal layer, which is formed on the first surface of the substrate; and
at least an insulation cover layer, which covers the first surface of the substrate and the metal layer;
wherein the water-resistance module is molded to cover the second surface of the substrate, the insulation cover layer, and the roughness structure.

3. The lateral edge water-resistance structure as claimed in claim 2, wherein:
the insulation cover layer comprises a water-resistance module inlay zone formed therein;
the metal layer comprises a metal layer exposure zone formed therein to correspond to the water-resistance module inlay zone; and
the water-resistance module is molded to cover the metal layer exposure zone.

4. The lateral edge water-resistance structure as claimed in claim 3, wherein the metal layer exposure zone comprises a roughened structure.

5. The lateral edge water-resistance structure as claimed in claim 2, wherein the roughness structure is formed in the insulation cover layer and the substrate of the flexible circuit cable.

6. The lateral edge water-resistance structure as claimed in claim 2, wherein the roughness structure is formed in one of the insulation cover layer and the substrate of the flexible circuit cable.

7. The lateral edge water-resistance structure as claimed in claim 2, wherein the first surface of the substrate comprises at least a copper residue zone formed thereon and the roughness structure is formed in the copper residue zone.

8. The lateral edge water-resistance structure as claimed in claim 1, wherein the roughness structure is constructed as one of a wavy configuration, a serrated configuration, and a circular arc configuration.

9. The lateral edge water-resistance structure as claimed in claim 1, wherein the roughness structure is constructed by recessing the lateral edge in a recessing direction in the water resistant section to form the roughness structure.

10. The lateral edge water-resistance structure as claimed in claim 1, wherein the roughness structure is constructed by extending the lateral edge in a projection direction in the water resistant section to form the roughness structure.

11. The lateral edge water-resistance structure as claimed in claim 1, wherein the first surface of the substrate comprises at least a grounding line formed thereon.

12. The lateral edge water-resistance structure as claimed in claim 1, wherein the water-resistance module is made of an insulation material of one of silicon rubber, rubber, silica gel, plastic, and resin.

13. The lateral edge water-resistance structure as claimed in claim 1, wherein the water-resistance module is made of an electrically conductive material of one of silicon rubber, rubber, silica gel, plastic, and resin that comprises electrically conductive particles combined therein.

14. The lateral edge water-resistance structure as claimed in claim 1, wherein the roughness structure has a vertical surface and a metal layer is formed on the vertical surface.

15. The lateral edge water-resistance structure as claimed in claim 1, wherein the flexible circuit cable comprises a rigid circuit board bonded thereto, the rigid circuit board having an end edge that is spaced from the water resistant section by a distance.

16. The lateral edge water-resistance structure as claimed in claim 1, wherein the flexible circuit cable comprises a rigid circuit board bonded thereto, the rigid circuit board having an end edge extending to the water resistant section.

17. The lateral edge water-resistance structure as claimed in claim 1, wherein the flexible circuit cable comprises a liner layer attached thereto in the water resistant section.

18. The lateral edge water-resistance structure as claimed in claim 17, wherein the liner layer has a surface forming a roughened structure.

19. The lateral edge water-resistance structure as claimed in claim 17, wherein the liner layer has a surface in which a plurality of cavities that does not extend through the liner layer is formed.

20. The lateral edge water-resistance structure as claimed in claim 17, wherein the liner layer comprises a plurality of holes that extends through the liner layer formed therein.
